(19) United States
(12) Patent Application Publication
(10) Pub. No.: US 2026/0267991 A1
(43) Pub. Date: Sep. 10, 2026

(54) COMPUTING ASSET-BASED SECURITY SCORING

(71) Applicant: Microsoft Technology Licensing, LLC, Redmond, WA (US)

(72) Inventors: Asaf HARARI, Modiin (IL); Yaron David FRUCHTMANN, Herzliya (IL); Shay Chriba SAKAZI, Herzliya (IL); Idan HEN, Tel Aviv (IL); Tamer SALMAN, Haifa (IL); Evengy BOGOKOVSKY, Kfar Saba (IL); Ram Haim PLISKIN, Tel Aviv (IL)

(21) Appl. No.: 19/073,184

(22) Filed: Mar. 7, 2025

(51) Int. Cl. G06F 21/57

(52) U.S. Cl. CPC G06F 21/577; G06F 2221/034

(57) ABSTRACT

Security risks are scored for a system of computing assets. First security issue instances arising from a first computing asset in the system are identified. The first security issue instances are mapped to first security issue types having corresponding security issue type risk weights. The first computing asset is assigned a first criticality weight. A first asset level security score is generated for the first computing asset of the system of the computing assets as a function of at least first security issue type risk weights corresponding to the first security issue instances. A scope level security score is generated as a function of the first criticality weight and the first asset level security score. The scope level security score is improved by modifying the first computing asset to improve the first asset level security score of the first computing asset.

### BACKGROUND

A security score (e.g. a “secure score”) in computing is a metric used to evaluate the security posture of an organization's computing environment (e.g., on-premise, cloud). For example, a security score can measure how well an organization's computing environment aligns with security best practices and can identify aspects needing improvement. A security score aggregates various security findings into a single score, helping organizations quickly assess their current security situation. Generally, the higher the score, the lower the identified risk level.

Security scoring may include continuous assessment of the environment (e.g., using security monitoring tools), reflecting changes as new security measures are implemented or changed and/or new computing assets are deployed (e.g., computers, mobile devices, power supplies, storage devices, databases, routers, firewalls, Wi-Fi access points, modems, smart speakers, smart televisions) with the organization's computing environment. Security scores may be tied to actionable recommendations to improve the organization's security posture and may be visible on an organization's security dashboard to obtain a quick sense of the organization's security posture, potentially in comparison to other organizations. In effect, a security score helps organizations understand their current security status and prioritize actions to strengthen their computing security.

### SUMMARY

In some aspects, the techniques described herein relate to a method of scoring a security risk for a system of computing assets, the method including: identifying first security issue instances arising from a first computing asset in the system, wherein the first security issue instances are mapped to first security issue types having corresponding security issue type risk weights, and the first computing asset is assigned a first criticality weight; generating a first asset level security score for the first computing asset of the system of the computing assets as a function of at least first security issue type risk weights corresponding to the first security issue instances; generating a scope level security score as a function of the first criticality weight and the first asset level security score, wherein the scope level security score indicates a measurement of the security risk for a subset of the system of the computing assets; and improving the scope level security score by modifying the first computing asset to improve the first asset level security score of the first computing asset.

In some aspects, the techniques described herein relate to a computerized security scoring system for scoring a security risk for a system of computing assets, the computerized security scoring system including: memory; one or more hardware processors; an asset level security score generator storable in the memory, executable by the one or more hardware processors, and configured to identify first security issue instances arising from a first computing asset in the system, wherein the first security issue instances are mapped to first security issue types having corresponding security issue type risk weights, and the first computing asset is assigned a first criticality weight, and to generate a first asset level security score for the first computing asset of the system of the computing assets as a function of at least first security issue type risk weights corresponding to the first security issue instances; a scope level security score generator storable in the memory, executable by the one or more hardware processors, and configured to generate a scope level security score as a function of the first criticality weight and the first asset level security score, wherein the scope level security score indicates a measurement of the security risk for a subset of the system of the computing assets; and an administrative portal storable in the memory, executable by the one or more hardware processors, and configured to improve the scope level security score by modifying the first computing asset to improve the first asset level security score of the first computing asset.

In some aspects, the techniques described herein relate to one or more tangible processor-readable storage media embodied with instructions for executing on one or more processors and circuits of a computing device a process for scoring a security risk for a system of computing assets, the process including: identifying first security issue instances arising from a first computing asset in the system, wherein the first security issue instances are mapped to first security issue types having corresponding security issue type risk weights, and the first computing asset is assigned a first criticality weight; generating a first asset level security score for the first computing asset of the system of the computing assets as a function of at least first security issue type risk weights corresponding to the first security issue instances; generating a scope level security score as a function of the first criticality weight and the first asset level security score, wherein the scope level security score indicates a measurement of the security risk for a subset of the system of the computing assets; and improving the scope level security score by modifying the first computing asset to improve the first asset level security score of the first computing asset.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example scoring system for measuring the security posture of a system of computing assets.

FIG. 2 illustrates example components of a security scoring tool for measuring the security posture of a system of computing assets.

FIG. 3 illustrates example operations for measuring the security posture of a system of computing assets (e.g., scoring a security risk for the system).

FIG. 4 illustrates an example computing device for use in implementing the described technology.

### DETAILED DESCRIPTIONS

The term “security posture” refers to the overall security status of an organization's software, hardware, networks, information, and services. It can encompass the policies, procedures, and controls that an organization has implemented to prevent and respond to threats and attacks. In one perspective, the security posture refers to a view of how prepared and resilient an organization is against potential cyber threats. In characterizing a security posture, security scores can take into account security issues and associated risks, such as recommendations and vulnerabilities detected in the organization's computing assets, along with their likelihood and potential impact. Accordingly, security scores can help Chief Information Security Officers (CISOs) prioritize the organization's security efforts, track progress over time, and identify vulnerable assets.

Characterizing an organization's security posture, however, is a complex task that can provide overly complicated results that can be difficult for a security administrator to understand. Alternatively, depending on the implementation, generating a single security score (without more) to illustrate the organization's security posture might overgeneralize the data collected about the security posture, thereby making the security score less accurate and potentially less helpful than intended. Furthermore, the lack of standardization of different implementations of security scoring can provide different ways of measuring security risks, making it difficult to compare and/or transfer compatible security scores between different organizations. For example, some security scoring can lack a solid scientific basis, be prone to biases, and present scores based on different/unstable ranges and behaviors, thereby yielding inaccurate, incompatible, indecipherable, and/or unhelpful results.

The described technology addresses these concerns by scoring a security posture of a system of computing assets by considering the criticality of assets to the system's operation, categorizing individual security issues into risk levels, assigning risk weights to the categories, collecting security issue instances arising from one or more computing assets, and then generating “asset level” security scores for the computing assets of the system based on the categorized security issue types and their corresponding risk weights. “Security issue types” refers to categories of security issues that might arise in a system, such as a misconfigured firewall, an expired password, an expired certificate, suspect behavior associated with a user, etc. In contrast, a “security issue instance” refers to an identified occurrence of one of the security issue types. For example, a security issue instance might be an identified misconfiguration of a specific firewall in a specific part of the system and a given point in time and an expired certificate for a specific service in a specific virtual machine in a specific server in a datacenter.

Multiple security issue instances may arise from a single computing asset concurrently. The term “computing assets” is broadly defined as assets deployed within a computing system, including, without limitation, one or more of the following: computers, mobile computing devices, Internet-of-Things devices, networking equipment, HVAC systems, power supplies, firewalls, modems, virtual machines, WIFI access points, etc. Such computing assets may be subject to one or more security issues, such as a misconfiguration, a fault, a physical state (e.g., being lost or stolen), and may have different levels of criticality within the overall computing system (e.g., a smart light switch in an already heavily secured room may be much less critical than a server running one hundred virtual machines for active users).

Thereafter, a scope level security score is generated using the multiple asset level security scores to provide a broader measure of the security posture. A “scope level” security score measures the security posture of an entire system or some defined subset of the system (e.g., all storage systems, all networking devices, assets in the United States, assets connected to a specified part of the overall system or able to access a specified set of data). In various implementations of the described technology, the scope level security scores are normalized/standardized to a range of 0 to 1, although other standardized ranges and scoring protocols may be employed. Such normalization/standardization allows meaningful comparisons of scope level security scores across different scopes of computing assets, across different computing systems, and/or across different security monitoring tools.

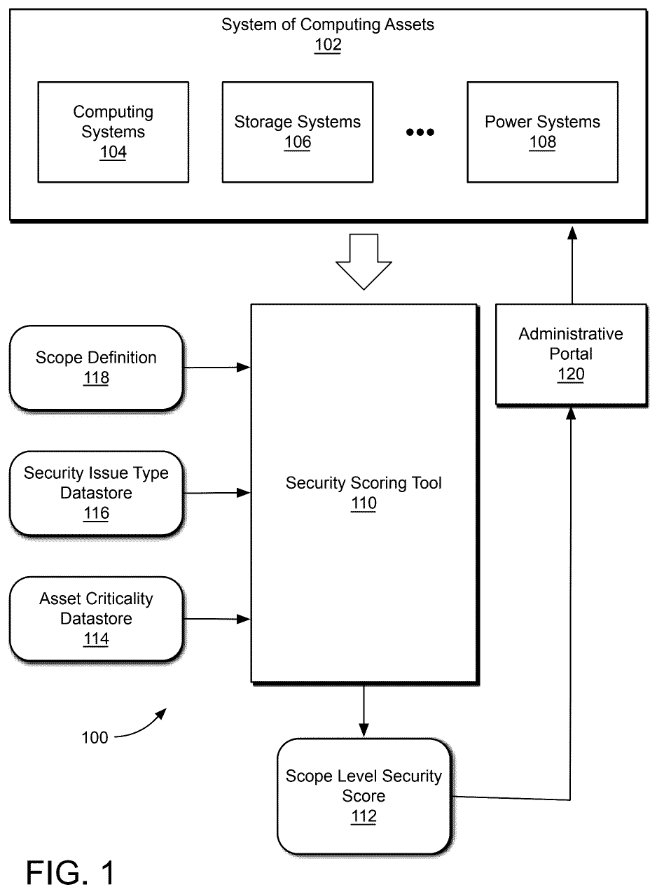

FIG. 1 illustrates an example scoring system 100 for measuring the security posture of a system 102 of computing assets. The system 102 includes multiple computing assets, including, within limitation, a combination of computing systems 104 (e.g., laptops, servers, mobile devices), storage systems 106, power systems 108, and/or other assets in an organization's computing system. In at least one implementation, the computing assets may share common characteristics, including without limitation, that they all contribute to the operation of the system 102, and they all can be monitored by a security monitoring tool or other monitoring method. A security scoring tool 110. which identifies security issue instances arising from the computing assets, quantifies risks corresponding to the identified security issue instances, and presents the quantified risk in the form of a scope level security score 112.

In one implementation, the computing assets of the system 102 are classified into two criticality categories (e.g., critical or non-critical), although other implementations may employ more than two categories (e.g., highly critical, moderately critical, or non-critical). The criticality categories are mapped to predefined criticality weights for the computing assets (e.g., critical assets have a criticality weight of one, and non-critical assets have a criticality weight of zero). For example, a set of “critical assets” may include those assets that are essential to the acceptable operation, security, and integrity of the system 102, whereas a set of “non-critical assets” may include those assets that are less than essential to the acceptable operation, security, and integrity. The dividing line between essential and less-than-essential may be defined by the hardware vendors, computing network engineers, security engineers, system owners, and/or other similarly-situated professionals, and can be informed by the overall security posture needed to maintain the acceptable operation, security, and integrity of the system 102.

For example, a computing system managing a supply line of plush dog toys may have less strict operational and confidentiality requirements than a computing system managing a nuclear power plant. As such, the acceptable security postures between these two example applications can vary dramatically, and the criticality of the underlying computing assets that implement the system 102 can vary dramatically as well. In FIG. 1, the computing assets of the system 102 and their corresponding asset criticality weights are recorded in an asset criticality datastore 114, which is accessible by the security scoring tool 110. It should be understood that the parameters (e.g., computing assets and their corresponding levels of criticality) in the asset criticality datastore 114 may be updated from time to time. As such, a criticality weight of a computing asset within a computing system represents a measure of the contribution of the computing asset to the acceptable operation, security, and/or integrity of the computing system.

In addition to the computing assets and their corresponding asset criticality weights, the security scoring tool 110 also takes as input a set of security issue types supported by the security scoring tool 110. Instances of the security issue types can be monitored and identified using security monitoring tools. Example security issue types may include, without limitation, detected network breaches, detected data breaches, unmanaged attack surfaces, misconfiguration of a firewall or other computing assets, lack of or misconfiguration of multifactor authentication, an unenforced or inadequate password policy, an incorrect policy setting in a cloud computing environment, unlocked computing room doors, excessive computing room temperatures, excessive vibrations in the computing room, and many other issues that present an operational and/or security risk to the system 102. Typically, the set of such security issue types can be defined by hardware vendors, computing network engineers, security engineers, system owners, and/or other similarly situated professionals. Security issue instances include actual events in which security issues of some supported type have arisen (e.g., have been detected) from one or more computing assets. In FIG. 1, the set of security issue types supported by the security scoring tool 110 is stored in a security issue type datastore 116. It should be understood that the security issue types in the security issue type datastore 116 may be updated from time to time.

A security issue type is classified based on its level of risk into a risk category (e.g., Critical, High, Medium, and Low), although two or more risk categories are contemplated. A security issue type is assigned a corresponding security issue type risk weight (e.g., by a security monitoring tool and/or organizational policies) based on its assigned risk category. For example, 0.1 for a security issue type having a Critical risk level, and 0.9 for a security issue type having a Low risk level. Typically, these security issue types and their corresponding risk weights can be defined by hardware vendors, computing network engineers, security engineers, system owners, and/or other similarly situated professionals and can be stored in the security issue type datastore 116. It should be understood that the security issue types and their risk weights in the security issue type datastore 116 may be updated from time to time.

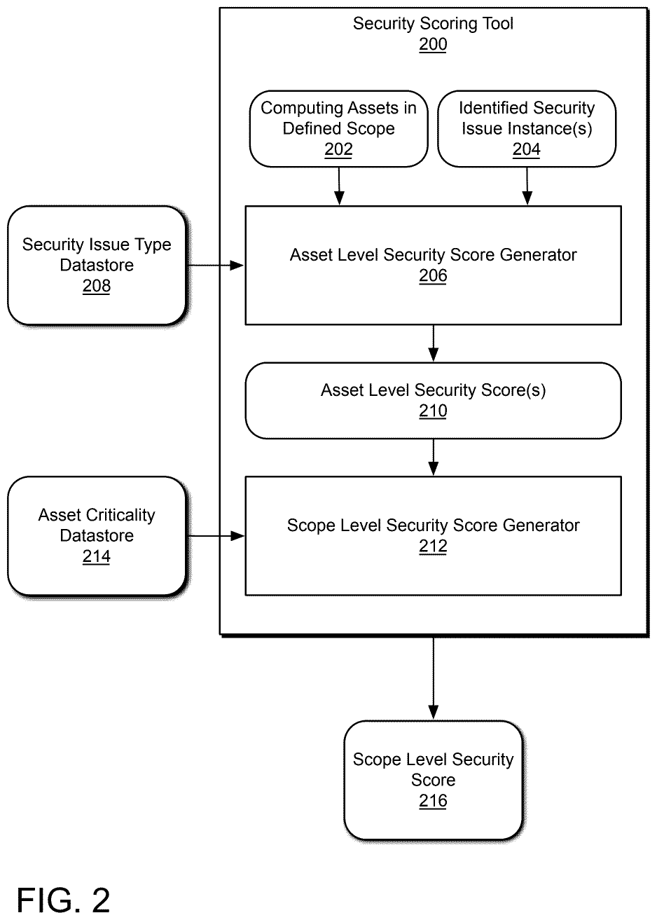

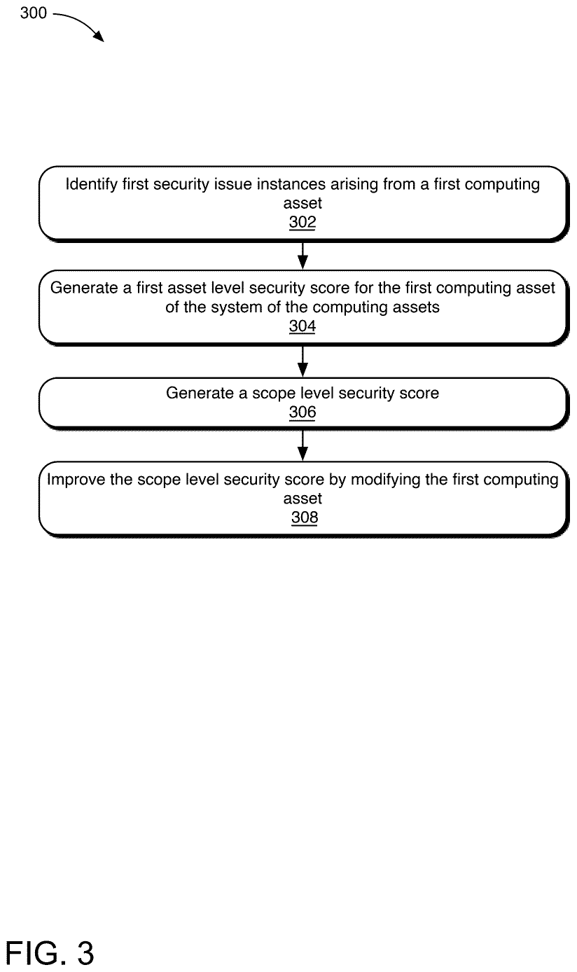

This description of FIG. 1 provides an overview of the described technology, whereas operational details of the security scoring tool 110 are provided primarily with respect to FIGS. 2 and 3. Generally, the security scoring tool 110 computes asset level security scores for the computing assets implicated in the identified security issue instances and then aggregates the asset level security scores into a scope level security score, wherein “scope” refers to a set or proper subset of the set of all the computing assets in the system 102. For example, a security engineer can specify the scope of computing assets he/she would like to investigate (e.g., the entire computing system, the storage assets, the assets in a specified geographical region).

Various security monitoring tools can identify security issue instances in a computing system (e.g., system 102). Generally, a security monitoring tool in computer systems is a software application and/or hardware device that continuously tracks, detects, and/or issues alerts of security threats and vulnerabilities within a computing environment. These tools are integral to maintaining the security posture of a system by identifying potential breaches, misconfigurations, and other security issues in real time. Examples of such tools include vulnerability scanners like Microsoft Defender for Endpoint, which scans network devices for vulnerabilities, penetration testing tools used by third parties to simulate attacks, and continuous security monitoring solutions like Azure Security Center, Microsoft Defender for Cloud, and Azure Sentinel. These tools help security engineers and administrators understand and mitigate risks by providing detailed insights into the security status of their systems, thus ensuring that protective measures are implemented effectively.

A security engineer can input a scope definition 118 identifying the computing assets to be included in the scope of interest (e.g., all storage devices, all routers, a subset of firewalls) to generate the scope level security score 112 (e.g., a secure score) for that scope within the system 102. As previously described, the scope level security score 112 is generated using asset level security scores of the computing assets implicated in the one or more identified security issue instances, such that the scope level security score 112 is coupled directly to the contribution of individual computing assets to the one or more security issue instances. One technical benefit of this approach is to provide a scope level security score 112 that can be decomposed into the contributions of individual computing assets of the system 102 to identify security issues in such a way that a security engineer can track the security issue instances of the system 102 down to the specific computing asset contributing to the security issue instance.

Once a scope level security score has been computed that highlights one or more security issue instances of satisfying a scope level security risk condition (e.g., a score exceeding a threshold), an administrative portal 120 can access the system 102, access one or more computing assets in the system 102 having an asset level security score satisfying an asset level security risk condition (e.g., a score exceeding a threshold), and modify those computing assets to improve the scope level security score of the system 102. An “asset level security score” refers to a measure of a computing asset's contribution to the security/risk in a system based on the security issue instances arising from that computing asset at a given time or time period. Examples of modifications may include, without limitation, adjusting policies to be more secure, adjusting configurations of computing devices, enabling/disabling one or more computing devices, adding/removing one or more computing devices to the system, and replacing defective computing devices. By providing a scope level security score that is based on individual asset level security scores, a security engineer can identify the individual computing assets contributing the most to the unsatisfactory scope level security score because the corresponding asset level security scores are also unsatisfactory (e.g., undesirably reduced or not satisfying an asset level security risk condition). As such, the administrative portal 120 can access the “suspect” computing assets in the system 102 and attempt to rectify one or more security issue instances arising from those “suspect” computing assets.

FIG. 2 illustrates example components of a security scoring tool 200 for measuring the security posture of a system of computing assets. Given one or more identified security issue instances in a computing system, a collection of computing assets 202 is identified based on a defined scope (e.g., supplied by a security engineer). An asset level security score generator 206 receives various inputs, including without limitation one or more of (1) notice of one or more identified security issue instances 204 (e.g., from one or more security monitoring tools), (2) identification of the computing assets 202 in a defined scope (e.g., specified by a security engineer), and (3) a security issue type risk weight (not shown) applied to the security issue types (e.g., critical, medium, low) of the one or more identified security issue instances 204, wherein the risk weights can be retrieved from a security issue type datastore 208 in some implementations. A security issue type risk weight provides a measure of how large a risk a given type of security issue is to acceptable operation, security, or integrity of the system. For example, a slightly higher than desired operating temperature of a power supply may be much less risky to the operation, security, or integrity of the system (associated with a lower relative risk weight) than loss of power to an uninterruptible power supply with a bad battery (associated with a higher relative risk weight).

The identified security issue instances 204 are mapped to or annotated with various computing assets from which a security issue instance arises. For example, multiple computing servers in the system may have an incorrect policy (a first security issue instance) and some of those servers may expired credentials (a second security issue instance). By associating identified security issue instances with individual computing assets, the security scoring tool 200 can determine a per-asset security score (“an asset level security score”) for the computing assets in a scope.

With these inputs, the asset level security score generator 206 computes an asset level security score 210 for individual computing assets (“Assets”). In one implementation, the asset level security score generator 206 computes the asset level security score 210 using the following operations, although some operations may vary in other implementations:
1. For each Assetⱼ of a set of J computing assets in a defined scope, identify security issue instances I arising from the Assetⱼ. In various implementations, the security issue instances are detected and communicated by a security monitoring tool, although other identification sources may be employed. Each security issue instance i corresponds to a risk category (e.g., Critical, . . . Low). Each security issue type corresponds to a security issue type risk weight (e.g., 0.9 for Critical, . . . , 0.01 for Low), which provides a metric of how serious a risk the security issue type is considered to be (e.g., by a security engineer, a system owner) to the operation, security, or integrity of the system.
2. For each security issue instance i, assign a per-security-issue-instance risk weight InstanceRiskᵢ for the security issue instance i as the security issue type risk weight corresponding to the security issue type of that instance i, and a per-security-instance security score for the Assetⱼ (also called a per-asset securance metric) as a function of the per-security-issue-instance risk weights InstanceRiskᵢ(e.g., (1−Instance Riskᵢ)).
3. For each Assetⱼ, compute an asset level security score as a multiplicative product of the security issue type risk weights of the security issue instances I arising from that asset.

Accordingly, based on system reliability theory, a joint probability function is employed in an example implementation, as shown below in Equation (1).

$${SecurityScore}_{{Asset}_{j}} = {\prod }_{I}^{1} ( 1 - {TypeRisk}_{i} ) = {\prod }_{I}^{1} ( {SecuranceMetric}_{i} ) \qquad ( 1 )$$

where SecurityScore_{Asset}_{ⱼ} denotes a per-asset security score for a computing asset j, i denotes an index of security issue instances from 1 to I arising from that asset j, InstanceRiskᵢ denotes the per-security-issue-instance risk weight for security issue i, and SecuranceMetricᵢ denotes a per-security-instance security score for the Assetⱼ. The capital Greek letter pi denotes a product operator, multiplying securance metrics for the identified security issue instances corresponding to the Assetⱼ, where i increments from 0 to the number of security issue instances I arising from the Assetⱼ. The SecuranceMetricᵢ is defined as a measure of security and relates to the InstanceRiskᵢ as follows:

$${SecuranceMetric}_{i} = 1 - {InstanceRisk}_{i}$$

Other algorithms may be employed to compute the asset level security scores.

Accordingly, the asset level security score generator 206 computes the asset level security score 210 for individual computing assets in the defined scope based on the risk levels attributed to the identified security issues arising from the asset.

After the asset level security score generator 206 computes the asset level security score 210 for individual computing assets in the defined scope, a scope level security score generator 212 inputs the asset level security scores and criticality weights for the identified computing assets, which can be stored in an asset criticality datastore 214. With these inputs, the scope level security score generator 212 aggregates the asset level security scores for multiple computing assets into a scope level security score 216 for the defined scope (e.g., the entire system for an organization or some proper subset of the computing assets of the system). In one implementation, the scope level security score generator 212 employs an algorithm of the form shown below in Equation (2), although other variations of the algorithm and also other algorithms may be used to aggregate the asset level security scores into the scope level security score 216:

$${SecureScore}_{{Scope}_{j}} = \frac{{\sum }_{n}^{0} ( {CriticalityW}_{{Asset}_{i}} * {SecureScore}_{{Asset}_{i}} )}{{\sum }_{n}^{0} {CriticalityW}_{{Asset}_{i}}} \qquad ( 2 )$$

where the criticality of a given asset i, denoted as CriticalityW_{Asset}_{ᵢ}, is determined according to:

$$IF {SecurityScore}_{{Asset}_{i}} < 1 AND {Criticality}_{{Asset}_{i}} == 1 , \\ THEN {CriticalityW}_{{Asset}_{i}} = 1 , \\ ELSE {CriticalityW}_{{Asset}_{i}} = {CriticalityW}_{RegularAsset}$$

and where CriticalityW denotes the criticality weights of assets (e.g., 100 for critical assets and 1 for regular assets, although these weights are merely examples—other weight values may be employed and they may change over time), and Criticality is a binary indicator denoting the criticality category of an asset, such that
a critical asset i has Criticality_{Asset}_{ᵢ}=1 and
a regular asset i (e.g., a noncritical asset) has Criticality_{Asset}_{ᵢ}=0 (or some other low number).
   As such, criticality weights are mapped to criticality categories for assets. In other implementations, the criticality category is not non-binary, and may have more than two types mapped to more than two criticality weights. In this manner, the criticality weights of the assets are functions of the corresponding asset level security score (e.g., being dependent upon whether the asset level security score for the asset is less than 1) and the corresponding asset criticality type.

FIG. 3 illustrates example operations 300 for measuring the security posture of a system of computing assets (e.g., scoring a security risk for the system). A security issue identification operation 302 identifies first security issue instances arising from a first computing asset in the system. The first security issue instances are mapped to first security issue types having corresponding security issue type risk weights, and the first computing asset is assigned a first criticality weight. In many scenarios, more than one security issue instance will arise from a single asset. The table below provides examples of such relationships.

TABLE 1
Example Mapping of Security Instances, Types,
Categories, and Type Risk Weights

| | | Security | Security |
|---|---|---|---|
| Security | Security | Issue Type | Issue Type |
| Issue Instance | Issue Type | Category | Risk Weight |
| SecurityIssueInstanceᵢ | Misconfigured | Critical | 0.0001 |
| | Firewall | | |
| SecurityIssueInstanceᵢ₊₁ | Uninterruptible | Low | 0.9999 |
| | Power Supply | | |
| | Battery Lifecycle | | |
| | at 70% | | |

An asset level scoring operation 304 generates a first asset level security score for the first computing asset of the system of the computing assets as a function of at least first security issue type risk weights corresponding to the first security issue instances. In one implementation, the asset level scoring operation 304 generates the first securance metrics for the first security issue instances arising from the first computing asset based on the security issue types of the first security issue instances and the security issue type risk weights corresponding to the first security issue instances and computing the first asset level security score as a multiplicative product of the first securance metrics for the first security issue instances. In one implementation, a securance metric is based on the following, although variations of this relation may be employed:

$${SecuranceMetric}_{i} = 1 - {InstanceRisk}_{i}$$

A scope level scoring operation 306 generates a scope level security score as a function of the first criticality weight and the first asset level security score. The scope level security score indicates a measurement of the security risk for a subset of the system of the computing assets. In one implementation, the scope level scoring operation 306 computes a relationship in the form of Equation (1).

A modification operation 308 improves the scope level security score by modifying the first computing asset to improve the first asset level security score of the first computing asset. In one implementation, the modification operation 308 modifies the first computing asset security score via an administrative portal to increase the first asset level security score of the first computing asset, although other actions may also be employed including, without limitation, replacing the asset, repairing the asset, adding or removing an asset, increase/decreasing power supplied to the asset, and adjusting temperature in the room containing the asset. In a scenario in which a higher security score denotes higher security/less risk, improving a security score includes increasing the security score, although some paradigms may invert the security score scale or use another form of indicating more/less secure. The modification operation 308 may, in some implementations, compute a sum of multiplicative products of at least the first criticality weights multiplied by the first asset level security score and dividing the sum by a summation of at least the first criticality weights (see Equation 2).

In many scenarios, more than one computing asset will trigger security an instance of a security type within the system. Accordingly, the method may include identifying second security issue instances arising from a second computing asset in the system. The second security issue instances are mapped to second security issue types having corresponding security issue type risk weights, and the second computing asset is assigned a second criticality weight. Thereafter, the method generates a second asset level security score for the second computing asset of the system of the computing assets as a function of at least second security issue type risk weights corresponding to the second security issue instances, wherein generating the scope level security score comprises computing the sum of the multiplicative products of at least the first criticality weights multiplied by the first asset level security score and the second criticality weights multiplied by the second asset level security score and dividing the sum by a summation of at least the first criticality weights and the second criticality weights. In some implementations, the first criticality weight is a function of the first asset level security score and the second criticality weight is a function of the second asset level security score.

As such, the described technology enables a consistent and comparable view of security risks in a computing system. Additionally, implementations of the security scoring tool are designed on a solid scientific basis, reducing biases, and enabling stable and accurate representation of the customer's true security posture. The security scoring algorithms make the score more understandable and user-friendly, encouraging customer engagement and adoption. Some technical advantages of this approach:

### Interpretability

Each scoring phase and component has inheritability and explanation.
Security issue level—According to security experts, for example, a critical security issue decreases securance around five times more than a high security issue, nine times more than a medium security issue, etc.
Asset level—Multiplication of assessments “securance reduction” resulting asset secure score between 1-0, assets in risk will approach 0.
Scope level—Average of the computing assets' security scores asymptotically approaches the ratio between secured computing assets and computing assets in risk.
   Example: Tenant with 100 resources, 30 in risk (critical assessment, scores close to 0), 70 secured resources (no assessments/low assessments, score close to 1). Aggregated scope level security score: ~0.7

### Stability

Security scores are within a consistent, well-defined range (e.g., between 0 and 1) to allow comparisons with other computing systems and standardized security scores across various security monitoring tools.
Addition of assessment on unhealthy computing assets will have little effect on the score.

### Customer-Friendly

Simple—a small number of parameters and arguments.
Comparable between different scopes and customers.
Straightforward security issues/vulnerable assets posterization.
Interpretable.

### Reflects True Security Posture

Considers the risk as reflected from risk levels including asset criticality.
Considers asset criticality.
When we compute Asset Level criticality by multiplying security issues weights (numbers between 0 and 1):
   Asset “securance” is bound by the worst case, e.g., the asset with a critical issue cannot have a score greater than the corresponding criticality weight.
   Values decrease with each multiplication, placing more emphasis on the initial assessments of an asset and less on subsequent ones. For example, when the critical issue weight equals 0.1:
      § 1 critical->0.1
      § 2 critical->0.01
      § 3 critical->0.001

### Easy Implementation and Generalization

Can be used by different security products as long they map the risk into the four risk levels.
   Computes scores to each asset and then generalizes to scope.
   Straightforward drill down and investigation.
   Transferable—anyone can use it with its own risk levels.

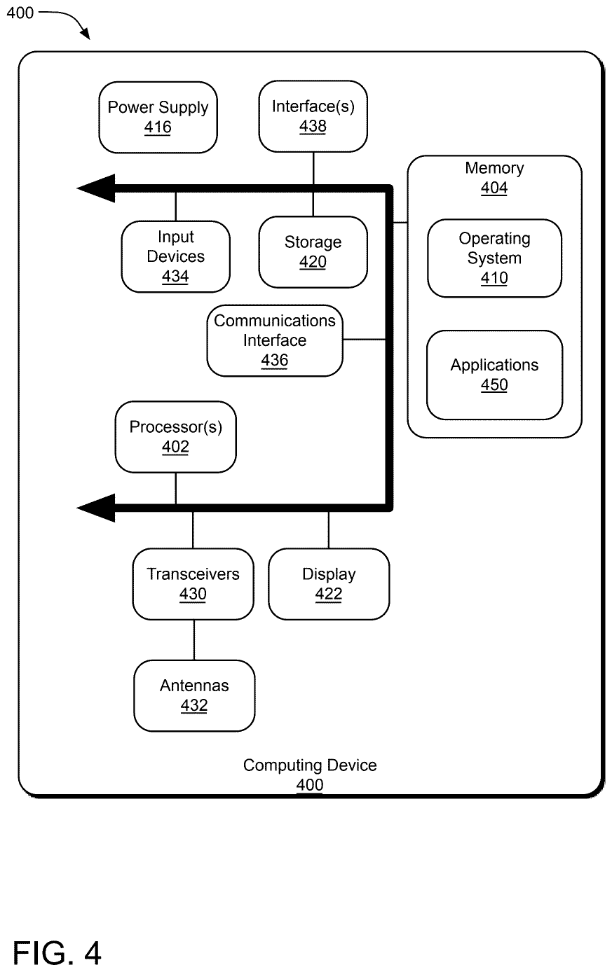

FIG. 4 illustrates an example computing device 400 for use in implementing the described technology. The computing device 400 may be a client computing device (such as a laptop computer, a desktop computer, or a tablet computer), a server/cloud computing device, an Internet-of-Things (IoT), any other type of computing device, or a combination of these options. The computing device 400 includes one or more hardware processor(s) 402 and a memory 404. The memory 404 generally includes both volatile memory (e.g., RAM) and nonvolatile memory (e.g., flash memory), although one or the other type of memory may be omitted. An operating system 410 resides in the memory 404 and is executed by the processor(s) 402. In some implementations, the computing device 400 includes and/or is communicatively coupled to storage 420.

In the example computing device 400, as shown in FIG. 4, one or more software modules, segments, and/or processors, such as applications 450, a security scoring tool, an asset level security score generator, a scope level security score generator, an administrative portal, and other program code and modules are loaded into the operating system 410 on the memory 404 and/or the storage 420 and executed by the processor(s) 402. The storage 420 may store security issues and corresponding weights, asset criticality, asset level security scores, scope level security scores, identification of computing assets in a defined scope, identified security issues, asset configurations, policies, and other data and be local to the computing device 400 or may be remote and communicatively connected to the computing device 400. In particular, in one implementation, components of a system for scoring a security risk for a system of computing assets may be implemented entirely in hardware or in a combination of hardware circuitry and software.

The computing device 400 includes a power supply 416, which may include or be connected to one or more batteries or other power sources, and which provides power to other components of the computing device 400. The power supply 416 may also be connected to an external power source that overrides or recharges the built-in batteries or other power sources.

The computing device 400 may include one or more communication transceivers 430, which may be connected to one or more antenna(s) 432 to provide network connectivity (e.g., mobile phone network, Wi-Fi®, Bluetooth®) to one or more other servers, client devices, IoT devices, and other computing and communications devices. The computing device 400 may further include a communications interface 436 (such as a network adapter or an I/O port, which are types of communication devices). The computing device 400 may use the adapter and any other types of communication devices for establishing connections over a wide-area network (WAN) or local-area network (LAN). It should be appreciated that the network connections shown are exemplary and that other communications devices and means for establishing a communications link between the computing device 400 and other devices may be used.

The computing device 400 may include one or more input devices 434 such that a user may enter commands and information (e.g., a keyboard, trackpad, or mouse). These and other input devices may be coupled to the server by one or more interfaces 438, such as a serial port interface, parallel port, or universal serial bus (USB). The computing device 400 may further include a display 422, such as a touchscreen display.

The computing device 400 may include a variety of tangible processor-readable storage media and intangible processor-readable communication signals. Tangible processor-readable storage can be embodied by any available media that can be accessed by the computing device 400 and can include both volatile and nonvolatile storage media and removable and non-removable storage media. Tangible processor-readable storage media excludes intangible and transitory communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 400. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of scoring a security risk for a system of computing assets, the method comprising: identifying first security issue instances arising from a first computing asset in the system, wherein the first security issue instances are mapped to first security issue types having corresponding security issue type risk weights, and the first computing asset is assigned a first criticality weight; generating a first asset level security score for the first computing asset of the system of the computing assets as a function of at least first security issue type risk weights corresponding to the first security issue instances; generating a scope level security score as a function of the first criticality weight and the first asset level security score, wherein the scope level security score indicates a measurement of the security risk for a subset of the system of the computing assets; and improving the scope level security score by modifying the first computing asset to improve the first asset level security score of the first computing asset.

Clause 2. The method of clause 1, wherein generating the first asset level security score comprises: generating first securance metrics for the first security issue instances arising from the first computing asset based on security issue types of the first security issue instances and security issue type risk weights corresponding to the first security issue instances; and computing the first asset level security score as a multiplicative product of the first securance metrics for the first security issue instances.

Clause 3. The method of clause 1, wherein improving the scope level security score comprises: modifying the first computing asset via an administrative portal to increase the first asset level security score of the first computing asset.

Clause 4. The method of clause 1, wherein generating the scope level security score comprises: computing a sum of multiplicative products of at least the first criticality weight multiplied by the first asset level security score and dividing the sum by a summation of at least the first criticality weight.

Clause 5. The method of clause 1, further comprising: identifying second security issue instances arising from a second computing asset in the system, wherein the second security issue instances are mapped to second security issue types having corresponding security issue type risk weights, wherein the second computing asset is assigned a second criticality weight; and generating a second asset level security score for the second computing asset of the system of the computing assets as a function of at least second security issue type risk weights corresponding to the second security issue instances, wherein generating the scope level security score comprises computing a sum of multiplicative products of at least the first criticality weight multiplied by the first asset level security score and the second criticality weight multiplied by the second asset level security score, and dividing the sum by a summation of at least the first criticality weight and the second criticality weight.

Clause 6. The method of clause 1, wherein the first criticality weight represents a measure of contribution of the first computing asset to acceptable operation, security, or integrity of the system, wherein an acceptable metric is predefined.

Clause 7. The method of clause 1, wherein the first criticality weight is a function of the first asset level security score and a criticality category assigned to the first computing asset.

Clause 8. A computerized security scoring system for scoring a security risk for a system of computing assets, the computerized security scoring system comprising: memory; one or more hardware processors; an asset level security score generator storable in the memory, executable by the one or more hardware processors, and configured to identify first security issue instances arising from a first computing asset in the system, wherein the first security issue instances are mapped to first security issue types having corresponding security issue type risk weights, and the first computing asset is assigned a first criticality weight, and to generate a first asset level security score for the first computing asset of the system of the computing assets as a function of at least first security issue type risk weights corresponding to the first security issue instances; a scope level security score generator storable in the memory, executable by the one or more hardware processors, and configured to generate a scope level security score as a function of the first criticality weight and the first asset level security score, wherein the scope level security score indicates a measurement of the security risk for a subset of the system of the computing assets; and an administrative portal storable in the memory, executable by the one or more hardware processors, and configured to improve the scope level security score by modifying the first computing asset to improve the first asset level security score of the first computing asset.

Clause 9. The computerized security scoring system of clause 8, wherein the asset level security score generator is further configured to generate first securance metrics for the first security issue instances arising from the first computing asset based on security issue types of the first security issue instances and security issue type risk weights corresponding to the first security issue instances and to compute the first asset level security score as a multiplicative product of the first securance metrics for the first security issue instances.

Clause 10. The computerized security scoring system of clause 8, wherein the administrative portal is configured to improve the scope level security score by modifying the first computing asset via an administrative portal to increase the first asset level security score of the first computing asset.

Clause 11. The computerized security scoring system of clause 8, wherein the scope level security score generator is configured to generate the scope level security score by computing a sum of multiplicative products of at least the first criticality weight multiplied by the first asset level security score and dividing the sum by a summation of at least the first criticality weight.

Clause 12. The computerized security scoring system of clause 8, wherein the asset level security score generator is further configured to identify second security issue instances arising from a second computing asset in the system, wherein the second security issue instances are mapped to second security issue types having corresponding security issue type risk weights, wherein the second computing asset is assigned a second criticality weight, and to generate a second asset level security score for the second computing asset of the system of the computing assets as a function of at least second security issue type risk weights corresponding to the second security issue instances, wherein generating the scope level security score comprises computing a sum of multiplicative products of at least the first criticality weight multiplied by the first asset level security score and the second criticality weight multiplied by the second asset level security score, and dividing the sum by a summation of at least the first criticality weight and the second criticality weight.

Clause 13. The computerized security scoring system of clause 8, wherein the first criticality weight represents a measure of contribution of the first computing asset to acceptable operation, security, or integrity of the system, wherein an acceptable metric is predefined.

Clause 14. The computerized security scoring system of clause 8, wherein the first criticality weight is a function of the first asset level security score and a criticality category assigned to the first computing asset.

Clause 15. One or more tangible processor-readable storage media embodied with instructions for executing on one or more processors and circuits of a computing device a process for scoring a security risk for a system of computing assets, the process comprising: identifying first security issue instances arising from a first computing asset in the system, wherein the first security issue instances are mapped to first security issue types having corresponding security issue type risk weights, and the first computing asset is assigned a first criticality weight; generating a first asset level security score for the first computing asset of the system of the computing assets as a function of at least first security issue type risk weights corresponding to the first security issue instances; and generating a scope level security score as a function of the first criticality weight and the first asset level security score, wherein the scope level security score indicates a measurement of the security risk for a subset of the system of the computing assets.

Clause 16. The one or more tangible processor-readable storage media of clause 15, wherein generating the first asset level security score comprises: generating first securance metrics for the first security issue instances arising from the first computing asset based on security issue types of the first security issue instances and security issue type risk weights corresponding to the first security issue instances; and computing the first asset level security score as a multiplicative product of the first securance metrics for the first security issue instances.

Clause 17. The one or more tangible processor-readable storage media of clause 15, wherein improving the scope level security score comprises: modifying the first computing asset via an administrative portal to increase the first asset level security score of the first computing asset.

Clause 18. The one or more tangible processor-readable storage media of clause 15, wherein generating the scope level security score comprises: computing a sum of multiplicative products of at least the first criticality weight multiplied by the first asset level security score and dividing the sum by a summation of at least the first criticality weight.

Clause 19. The one or more tangible processor-readable storage media of clause 15, further comprising: identifying second security issue instances arising from a second computing asset in the system, wherein the second security issue instances are mapped to second security issue types having corresponding security issue type risk weights, wherein the second computing asset is assigned a second criticality weight; and generating a second asset level security score for the second computing asset of the system of the computing assets as a function of at least second security issue type risk weights corresponding to the second security issue instances, wherein generating the scope level security score comprises computing a sum of multiplicative products of at least the first criticality weight multiplied by the first asset level security score and the second criticality weight multiplied by the second asset level security score, and dividing the sum by a summation of at least the first criticality weight and the second criticality weight.

Clause 20. The one or more tangible processor-readable storage media of clause 15, wherein the first criticality weight represents a measure of contribution of the first computing asset to acceptable operation, security, or integrity of the system, wherein an acceptable metric is predefined, and the first criticality weight is a function of the first asset level security score and a criticality category assigned to the first computing asset.

Clause 21. A system for scoring a security risk for a system of computing assets, the system comprising: means for identifying first security issue instances arising from a first computing asset in the system, wherein the first security issue instances are mapped to first security issue types having corresponding security issue type risk weights, and the first computing asset is assigned a first criticality weight; means for generating a first asset level security score for the first computing asset of the system of the computing assets as a function of at least first security issue type risk weights corresponding to the first security issue instances; means for generating a scope level security score as a function of the first criticality weight and the first asset level security score, wherein the scope level security score indicates a measurement of the security risk for a subset of the system of the computing assets; and means for improving the scope level security score by modifying the first computing asset to improve the first asset level security score of the first computing asset.

Clause 22. The system of clause 21, wherein the means for generating the first asset level security score comprises: means for generating first securance metrics for the first security issue instances arising from the first computing asset based on security issue types of the first security issue instances and security issue type risk weights corresponding to the first security issue instances; and means for computing the first asset level security score as a multiplicative product of the first securance metrics for the first security issue instances.

Clause 23. The system of clause 21, wherein the means for improving the scope level security score comprises an administrative portal for modifying the first computing asset to increase the first asset level security score of the first computing asset.

Clause 24. The system of clause 21, wherein the means for generating the scope level security score comprises: computing a sum of multiplicative products of at least the first criticality weight multiplied by the first asset level security score and dividing the sum by a summation of at least the first criticality weight.

Clause 25. The system of clause 21, further comprising means for identifying second security issue instances arising from a second computing asset in the system, wherein the second security issue instances are mapped to second security issue types having corresponding security issue type risk weights, wherein the second computing asset is assigned a second criticality weight; and means for generating a second asset level security score for the second computing asset of the system of the computing assets as a function of at least second security issue type risk weights corresponding to the second security issue instances, wherein generating the scope level security score comprises computing a sum of multiplicative products of at least the first criticality weight multiplied by the first asset level security score and the second criticality weight multiplied by the second asset level security score, and dividing the sum by a summation of at least the first criticality weight and the second criticality weight.

Clause 26. The system of clause 1, wherein the first criticality weight represents a measure of contribution of the first computing asset to acceptable operation, security, or integrity of the system, wherein an acceptable metric is predefined.

Clause 27. The system of clause 1, wherein the first criticality weight is a function of the first asset level security score and a criticality category assigned to the first computing asset.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of scoring a security risk for a system of computing assets, the method comprising:
identifying first security issue instances arising from a first computing asset in the system, wherein the first security issue instances are mapped to first security issue types having corresponding security issue type risk weights, and the first computing asset is assigned a first criticality weight;
generating a first asset level security score for the first computing asset of the system of the computing assets as a function of at least first security issue type risk weights corresponding to the first security issue instances;
generating a scope level security score as a function of the first criticality weight and the first asset level security score, wherein the scope level security score indicates a measurement of the security risk for a subset of the system of the computing assets; and
improving the scope level security score by modifying the first computing asset to improve the first asset level security score of the first computing asset.

2. The method of claim 1, wherein generating the first asset level security score comprises:
generating first securance metrics for the first security issue instances arising from the first computing asset based on security issue types of the first security issue instances and security issue type risk weights corresponding to the first security issue instances; and
computing the first asset level security score as a multiplicative product of the first securance metrics for the first security issue instances.

3. The method of claim 1, wherein improving the scope level security score comprises:
modifying the first computing asset via an administrative portal to increase the first asset level security score of the first computing asset.

4. The method of claim 1, wherein generating the scope level security score comprises:
computing a sum of multiplicative products of at least the first criticality weight multiplied by the first asset level security score and dividing the sum by a summation of at least the first criticality weight.

5. The method of claim 1, further comprising:
identifying second security issue instances arising from a second computing asset in the system, wherein the second security issue instances are mapped to second security issue types having corresponding security issue type risk weights, wherein the second computing asset is assigned a second criticality weight; and
generating a second asset level security score for the second computing asset of the system of the computing assets as a function of at least second security issue type risk weights corresponding to the second security issue instances, wherein generating the scope level security score comprises computing a sum of multiplicative products of at least the first criticality weight multiplied by the first asset level security score and the second criticality weight multiplied by the second asset level security score, and dividing the sum by a summation of at least the first criticality weight and the second criticality weight.

6. The method of claim 1, wherein the first criticality weight represents a measure of contribution of the first computing asset to acceptable operation, security, or integrity of the system, wherein an acceptable metric is predefined.

7. The method of claim 1, wherein the first criticality weight is a function of the first asset level security score and a criticality category assigned to the first computing asset.

8. A computerized security scoring system for scoring a security risk for a system of computing assets, the computerized security scoring system comprising:
memory;
one or more hardware processors;
an asset level security score generator storable in the memory, executable by the one or more hardware processors, and configured to identify first security issue instances arising from a first computing asset in the system, wherein the first security issue instances are mapped to first security issue types having corresponding security issue type risk weights, and the first computing asset is assigned a first criticality weight, and to generate a first asset level security score for the first computing asset of the system of the computing assets as a function of at least first security issue type risk weights corresponding to the first security issue instances;
a scope level security score generator storable in the memory, executable by the one or more hardware processors, and configured to generate a scope level security score as a function of the first criticality weight and the first asset level security score, wherein the scope level security score indicates a measurement of the security risk for a subset of the system of the computing assets; and
an administrative portal storable in the memory, executable by the one or more hardware processors, and configured to improve the scope level security score by modifying the first computing asset to improve the first asset level security score of the first computing asset.

9. The computerized security scoring system of claim 8, wherein the asset level security score generator is further configured to generate first securance metrics for the first security issue instances arising from the first computing asset based on security issue types of the first security issue instances and security issue type risk weights corresponding to the first security issue instances and to compute the first asset level security score as a multiplicative product of the first securance metrics for the first security issue instances.

10. The computerized security scoring system of claim 8, wherein the administrative portal is configured to improve the scope level security score by modifying the first computing asset via an administrative portal to increase the first asset level security score of the first computing asset.

11. The computerized security scoring system of claim 8, wherein the scope level security score generator is configured to generate the scope level security score by computing a sum of multiplicative products of at least the first criticality weight multiplied by the first asset level security score and dividing the sum by a summation of at least the first criticality weight.

12. The computerized security scoring system of claim 8, wherein the asset level security score generator is further configured to identify second security issue instances arising from a second computing asset in the system, wherein the second security issue instances are mapped to second security issue types having corresponding security issue type risk weights, wherein the second computing asset is assigned a second criticality weight, and to generate a second asset level security score for the second computing asset of the system of the computing assets as a function of at least second security issue type risk weights corresponding to the second security issue instances, wherein generating the scope level security score comprises computing a sum of multiplicative products of at least the first criticality weight multiplied by the first asset level security score and the second criticality weight multiplied by the second asset level security score, and dividing the sum by a summation of at least the first criticality weight and the second criticality weight.

13. The computerized security scoring system of claim 8, wherein the first criticality weight represents a measure of contribution of the first computing asset to acceptable operation, security, or integrity of the system, wherein an acceptable metric is predefined.

14. The computerized security scoring system of claim 8, wherein the first criticality weight is a function of the first asset level security score and a criticality category assigned to the first computing asset.

15. One or more tangible processor-readable storage media embodied with instructions for executing on one or more processors and circuits of a computing device a process for scoring a security risk for a system of computing assets, the process comprising:
identifying first security issue instances arising from a first computing asset in the system, wherein the first security issue instances are mapped to first security issue types having corresponding security issue type risk weights, and the first computing asset is assigned a first criticality weight;
generating a first asset level security score for the first computing asset of the system of the computing assets as a function of at least first security issue type risk weights corresponding to the first security issue instances; and
generating a scope level security score as a function of the first criticality weight and the first asset level security score, wherein the scope level security score indicates a measurement of the security risk for a subset of the system of the computing assets.

16. The one or more tangible processor-readable storage media of claim 15, wherein generating the first asset level security score comprises:
generating first securance metrics for the first security issue instances arising from the first computing asset based on security issue types of the first security issue instances and security issue type risk weights corresponding to the first security issue instances; and
computing the first asset level security score as a multiplicative product of the first securance metrics for the first security issue instances.

17. The one or more tangible processor-readable storage media of claim 15, wherein improving the scope level security score comprises:
modifying the first computing asset via an administrative portal to increase the first asset level security score of the first computing asset.

18. The one or more tangible processor-readable storage media of claim 15, wherein generating the scope level security score comprises:
computing a sum of multiplicative products of at least the first criticality weight multiplied by the first asset level security score and dividing the sum by a summation of at least the first criticality weight.

19. The one or more tangible processor-readable storage media of claim 15, further comprising:
identifying second security issue instances arising from a second computing asset in the system, wherein the second security issue instances are mapped to second security issue types having corresponding security issue type risk weights, wherein the second computing asset is assigned a second criticality weight; and
generating a second asset level security score for the second computing asset of the system of the computing assets as a function of at least second security issue type risk weights corresponding to the second security issue instances, wherein generating the scope level security score comprises computing a sum of multiplicative products of at least the first criticality weight multiplied by the first asset level security score and the second criticality weight multiplied by the second asset level security score, and dividing the sum by a summation of at least the first criticality weight and the second criticality weight.

20. The one or more tangible processor-readable storage media of claim 15, wherein the first criticality weight represents a measure of contribution of the first computing asset to acceptable operation, security, or integrity of the system, wherein an acceptable metric is predefined, and the first criticality weight is a function of the first asset level security score and a criticality category assigned to the first computing asset.
